(19) United States
(12) Patent Application Publication
(10) Pub. No.: US 2025/0251515 A1
(43) Pub. Date: Aug. 7, 2025

(54) OBJECT DETECTION APPARATUS

(71) Applicant: Honda Motor Co., Ltd., Tokyo (JP)

(72) Inventors: Shunsuke Konishi, Saitama (JP); Ryota Okutsu, Tokyo (JP); Daichi Saeki, Saitama (JP); Shuhei Masuoka, Utsunomiya-shi (JP)

(21) Appl. No.: 19/045,503

(22) Filed: Feb. 4, 2025

(30) Foreign Application Priority Data
Feb. 7, 2024 (JP) 2024-016895

(51) Int. Cl. G01S 17/931; G01S 7/48

(52) U.S. Cl. CPC G01S 17/931; G01S 7/4808

(57) ABSTRACT

An object detection apparatus includes a microprocessor configured to perform: calculating the absolute velocity of each measurement point corresponding to point cloud data based on the relative moving speed of the measurement points detected by the LiDAR and the absolute velocity of the subject vehicle, classifying the point cloud data into moving point cloud data and stationary point cloud data, and extracting change point cloud data from the stationary point cloud data, and identifying the moving object based on the change point cloud data. The microprocessor identifies a candidate moving object to become a candidate from among the objects detected by the LIDAR based on the change point group data, and determines whether or not the candidate moving object is the moving object based on at least one of the moving speed and moving direction of the candidate moving object.

### CROSS-REFERENCE TO RELATED APPLICATION

This application is based upon and claims the benefit of priority from Japanese Patent Application No. 2024-016895 filed on Feb. 7, 2024, the content of which is incorporated herein by reference.

### BACKGROUND

### Technical Field

The present invention relates to an object detection apparatus configured to detect an object in the surroundings of a vehicle.

### Related Art

In recent years, there has been a demand for a vehicle control system that leads to improvement of traffic safety and that contributes to development of a sustainable transportation system. As this type of device, a device that detects a moving object, by using machine learning from three-dimensional point cloud data that has been acquired by a LiDAR, is known (for example, see JP 2023-027736 A).

However, in the method of using machine learning as the device described in JP 2023-027736 A, the detection accuracy depends on the reliability of the learning model. Hence, the detection accuracy of the moving object may not be sufficiently ensured.

### SUMMARY

An aspect of the present invention is an object detection apparatus including: a detection unit configured to irradiate surroundings of the subject vehicle with an electromagnetic wave and detect an exterior environment situation around a moving body based on a reflected wave; and a microprocessor. The microprocessor is configured to perform: acquiring point cloud data detected by the detection unit in every predetermined period of time, the point cloud data including position information of a measurement point on a surface of an object from which the reflected wave is obtained and first speed information indicating a relative moving speed of the measurement point; acquiring second speed information indicating absolute moving speed of the moving body; calculating an absolute moving speed of each of a plurality of measurement points corresponding to the point cloud data, based on the first speed information and the second speed information; classifying the point cloud data into first point cloud data and second point cloud data other than the first point cloud data, the first point cloud data corresponding to the measurement point on the surface of the object having an absolute value of the absolute moving speed, the absolute value being equal to or larger than a predetermined speed; calculating a moved amount of the measurement point corresponding to the second point cloud data for the predetermined period of time; extracting, from the second point cloud data, predetermined point cloud data corresponding to the measurement point having the moved amount equal to or larger than a predetermined value; and identifying a moving object from among objects detected by the detection unit, based on the first point cloud data and the predetermined point cloud data. The moving body includes a first moving object identified based on the first point cloud data and a second moving object identified based on the second point cloud data. The microprocessor is configured to perform the identifying including extracting a candidate moving object to become a candidate of the second moving object from the objects detected by the detection unit, based on the predetermined point cloud data, and determining whether the candidate moving object is the second moving object, based on at least one of a moving speed and a moving direction of the measurement point corresponding to the candidate moving object.

### BRIEF DESCRIPTION OF DRAWINGS

The objects, features, and advantages of the present invention will become clearer from the following description of embodiments in relation to the attached drawings, in which:

FIG. 1 is a block diagram illustrating a configuration of main components of a vehicle control device including the object detection apparatus according to an embodiment of the present invention;

FIG. 2 is a diagram for describing a relationship between a relative moving speed of a moving object to be measured by a LiDAR and a moving direction of the moving object;

FIG. 3 is a flowchart illustrating an example of processing to be performed by a CPU of the controller in FIG. 1;

FIG. 4 is a diagram schematically illustrating an example of point cloud data acquired by the LiDAR;

FIG. 5A is a diagram schematically illustrating stationary point cloud data of a previous frame;

FIG. 5B is a diagram schematically illustrating the stationary point cloud data of a current frame;

FIG. 6A is a diagram schematically illustrating a situation in which positions of the stationary point cloud data of the previous frame and the stationary point cloud data of the current frame are aligned with each other;

FIG. 6B is a diagram illustrating the stationary point cloud data of the previous frame and the stationary point cloud data of the current frame after the position alignment;

FIG. 7 is a diagram schematically illustrating another example of point cloud data acquired by the LiDAR;

FIG. 8 is a diagram illustrating a situation in which a change point is extracted from the stationary point cloud data;

FIG. 9 is a diagram for describing a moving vector of a moving object;

FIG. 10A is a diagram for describing erroneous detection of a moving object;

FIG. 10B is a diagram for describing erroneous detection of a moving object;

FIG. 11A is a diagram for describing an example of a method for identifying the moving object that has been erroneously detected;

FIG. 11B is a diagram illustrating a situation in which the moving object that has been erroneously detected is identified;

FIG. 12 is a diagram for describing another example of a method for identifying the moving object that has been erroneously detected;

FIG. 13A is a diagram for describing a degree of the possibility that the subject vehicle approaches or collides with a moving object;

FIG. 13B is a diagram for describing a degree of the possibility that the subject vehicle approaches or collides with a moving object; and

FIG. 13C is a diagram for describing a degree of the possibility that the subject vehicle approaches or collides with a moving object.

### DETAILED DESCRIPTION OF THE INVENTION

Hereinafter, embodiments of the present invention will be described with reference to the drawings. An object detection apparatus according to an embodiment of the present invention is applicable to a vehicle having a self-driving capability, that is, a self-driving vehicle. Note that a vehicle to which the object detection apparatus according to the present embodiment is applied will be referred to as a subject vehicle to be distinguished from other vehicles, in some cases. The subject vehicle may be any of an engine vehicle having an internal combustion (engine) as a traveling drive source, an electric vehicle having a traveling motor as the traveling drive source, and a hybrid vehicle having an engine and a traveling motor as the traveling drive source. The subject vehicle is capable of driving not only in a self-drive mode that does not require a driver's driving operation but also in a manual drive mode that requires a driver's driving operation.

While a self-driving vehicle is moving in the self-drive mode (hereinafter, referred to as self-driving or autonomous driving), such a self-driving vehicle recognizes an exterior environment situation in the surroundings of the subject vehicle, based on detection data of an in-vehicle detection unit such as a camera or a light detection and ranging (LiDAR). The self-driving vehicle generates a driving path (a target path) at a predetermined time elapsed after the current time, based on a recognition result, and controls an actuator for driving so that the subject vehicle travels along the target path.

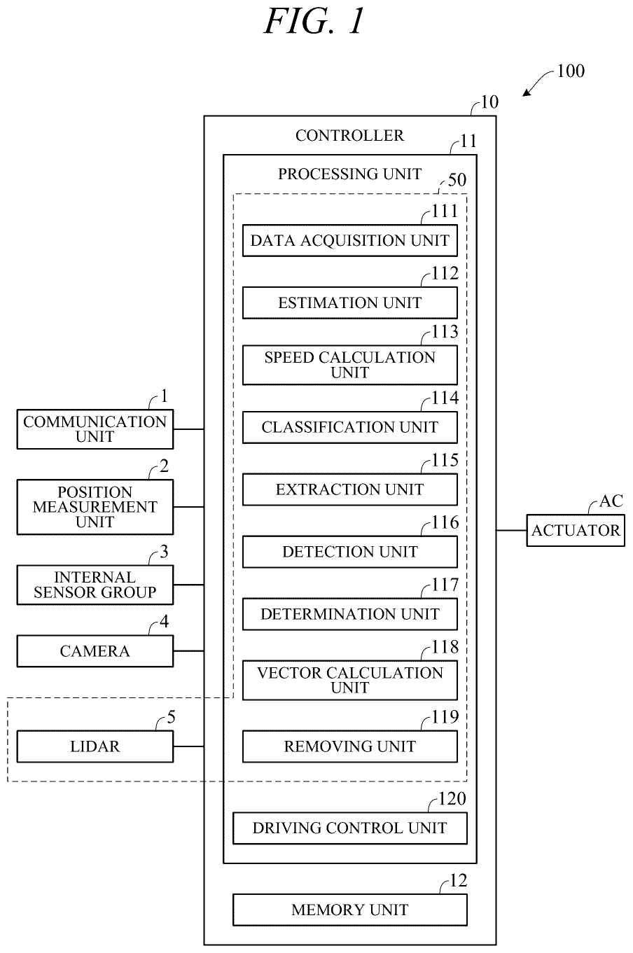

FIG. 1 is a block diagram illustrating a configuration of main components of a vehicle control device 100 including the object detection apparatus. The vehicle control device 100 includes a controller 10, a communication unit 1, a position measurement unit 2, an internal sensor group 3, a camera 4, a LiDAR 5, and an actuator AC for traveling. In addition, the vehicle control device 100 includes an object detection apparatus 50, which constitutes a part of the vehicle control device 100. The object detection apparatus 50 detects an object in the surroundings of a vehicle, based on detection data of the LiDAR 5.

The communication unit 1 communicates with various servers, not illustrated, through a network including a wireless communication network represented by the Internet network, a mobile telephone network, or the like, and acquires map information, traveling history information, traffic information, and the like from the servers regularly or at a given timing. The network includes not only a public wireless communication network but also a closed communication network provided for each predetermined management area, for example, a wireless LAN, Wi-Fi (registered trademark), Bluetooth (registered trademark), or the like. The acquired map information is output to a memory unit 12, and the map information is updated. The position measurement unit (GNSS unit) 2 includes a position measurement sensor that receives a position measurement signal transmitted from a position measurement satellite. The positioning satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle.

The internal sensor group 3 is a generic term for a plurality of sensors (internal sensors) that detect a traveling state of the subject vehicle. For example, the internal sensor group 3 includes a vehicle speed sensor that detects the vehicle speed of the subject vehicle, an acceleration sensor that detects the acceleration in a front-rear direction and the acceleration (lateral acceleration) in a left-right direction of the subject vehicle, a rotation speed sensor that detects the rotation speed of the traveling drive source, a yaw rate sensor that detects the rotation angular speed around the vertical axis of the center of gravity of the subject vehicle, and the like. The internal sensor group 3 also includes sensors that detect a driver's driving operation in the manual drive mode, for example, an operation on an accelerator pedal, an operation on a brake pedal, an operation on a steering wheel, and the like.

The camera 4 includes an imaging element such as a CCD or a CMOS, and captures an image of the surroundings of the subject vehicle (a forward side, a rearward side, and lateral sides). The LiDAR 5 irradiates a three-dimensional space in the surroundings of the subject vehicle with an electromagnetic wave (a reflected wave), and detects an exterior environment situation in the surroundings of the subject vehicle, based on the reflected wave. More specifically, the electromagnetic wave (a laser beam or the like) that has been irradiated from the LiDAR 5 is reflected on and returned from a certain point (a measurement point) on the surface of an object, and thus the distance from the laser source to such a point, the intensity of the electromagnetic wave that has been reflected and returned, the relative speed of the object located at the measurement point, and the like are measured. The electromagnetic wave of the LiDAR 5, which is attached to a predetermined position (a front part) of the subject vehicle is scanned in a horizontal direction and a vertical direction with respect to the surroundings (a forward side) of the subject vehicle. Thus, the position, the shape, the relative moving speed, and the like of an object (a moving object such as another vehicle or a stationary object such as a road surface or a structure) on a forward side of the subject vehicle are detected. Note that hereinafter, the above three-dimensional space will be represented by an X axis along an advancing direction of the subject vehicle, a Y axis along a vehicle width direction of the subject vehicle, and a Z axis along a height direction of the subject vehicle. Therefore, the above three-dimensional space will be referred to as an XYZ space, in some cases.

The actuator AC is an actuator for traveling to control the traveling of the subject vehicle. In a case where the driving power source is an engine, the actuator AC includes a throttle actuator that adjusts an opened degree (a throttle-opened degree) of a throttle valve of the engine. In a case where the traveling drive source is a traveling motor, the actuators AC includes the traveling motor. The actuator AC also includes a brake actuator that operates a braking device of the subject vehicle and a steering actuator that drives the steering device.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits, not illustrated, such as an I/O interface. Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 stores highly precise detailed map information (referred to as high-precision map information). The high-precision map information includes position information of roads, information of road shapes (curvatures or the like), information of road gradients, position information of intersections and branch points, information of the number of traffic lanes (driving lanes), widths of traffic lanes and position information of every traffic lane (information of center positions of traffic lanes and boundary lines between traffic lane positions), position information of landmarks (traffic lights, traffic signs, buildings, and the like) as marks on a map, and information of road surface profiles such as irregularities of road surfaces. In addition, the memory unit 12 stores programs for various types of control, information such as threshold values for use in the programs, and setting information for the in-vehicle detection unit such as the LiDAR 5.

The processing unit 11 includes, as a functional configuration, a data acquisition unit 111, an estimation unit 112, a speed calculation unit 113, a classification unit 114, an extraction unit 115, a detection unit 116, a determination unit 117, a vector calculation unit 118, a removing unit 119, and a driving control unit 120. Note that as illustrated in FIG. 1, the data acquisition unit 111, the estimation unit 112, the speed calculation unit 113, the classification unit 114, the extraction unit 115, the detection unit 116, the determination unit 117, the vector calculation unit 118, and the removing unit 119 are included in the object detection apparatus 50. Details of the data acquisition unit 111, the estimation unit 112, the speed calculation unit 113, the classification unit 114, the extraction unit 115, the detection unit 116, the determination unit 117, the vector calculation unit 118, and the removing unit 119 included in the object detection apparatus 50 will be described later.

In the self-drive mode, the driving control unit 120 generates a target path, based on an exterior environment situation in the surroundings of the vehicle, including a size, a position, a relative moving speed, and the like of an object that has been detected by the object detection apparatus 50. Specifically, the driving control unit 120 generates the target path to avoid collision or contact with the object or to follow the object, based on the size, the position, the relative moving speed, and the like of the object that has been detected by the object detection apparatus 50. The driving control unit 120 controls the actuator AC so that the subject vehicle travels along the target path. Specifically, the driving control unit 120 controls the actuator AC along the target path to adjust an accelerator opening or to actuate a braking device or a steering device. Note that in the manual drive mode, the driving control unit 120 controls the actuator AC in accordance with a driving command (a steering operation or the like) from the driver that has been acquired by the internal sensor group 3.

Details of the object detection apparatus 50 will be described. As described above, the object detection apparatus 50 includes the data acquisition unit 111, the estimation unit 112, the speed calculation unit 113, the classification unit 114, the extraction unit 115, the detection unit 116, the determination unit 117, the vector calculation unit 118, and the removing unit 119. The object detection apparatus 50 further includes the LiDAR 5.

The data acquisition unit 111 acquires, as detection data of the LiDAR 5, four-dimensional data (hereinafter, referred to as point cloud data) including position information indicating three-dimensional position coordinates of a measurement point on a surface of the object from which the reflected wave of the LiDAR 5 is obtained, and speed information indicating a relative moving speed of the measurement point. The point cloud data is acquired by the LiDAR 5 in units of frames, specifically, in every predetermined period of time (at time intervals determined by a frame rate of the LiDAR 5).

As a method for detecting the moving object from detection data (point cloud data) of the LiDAR 5, there is a method for performing clustering processing on the point cloud data and classifying the point cloud data into measurement points corresponding to the moving object and the other measurement points, and detecting the moving object. However, the point cloud data also includes information of the measurement points corresponding to a stationary object. For this reason, in a case where the point cloud data that has been acquired from the LiDAR 5 is used without change for the clustering processing, not only the measurement point cloud corresponding to the moving object but also the measurement point cloud corresponding to the stationary object is to be classified. Thus, a calculation load in the clustering processing may increase. Hence, in order to reduce the calculation load, there is a conceivable method for converting a relative moving speed indicated by speed information of each measurement point into an absolute speed (hereinafter, referred to as an absolute moving speed), classifying the point cloud data into stationary point cloud data corresponding to a stationary object and moving point cloud data corresponding to a moving object, based on the absolute moving speed, and performing the clustering processing on the moving point cloud data that has been classified.

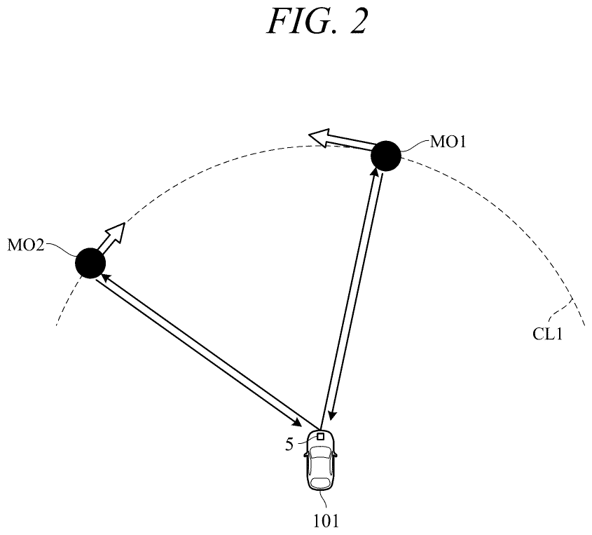

Depending on the moving direction of the moving object, however, the LiDAR 5 is not capable of measuring the relative moving speed, in some cases. FIG. 2 is a diagram for describing a relationship between the relative moving speed of a moving object to be measured by the LiDAR 5 and a moving direction of the moving object. In FIG. 2, a white arrow line represents a situation in which each of moving objects MO1 and MO2 moves in each direction of such an arrow. A solid arrow line schematically represents a situation in which the electromagnetic wave is irradiated by the LiDAR 5, is reflected on a surface of each of the moving objects MO1 and MO2, and is then returned. A broken line CL1 is an imaginary line that connects points equal in distance to each other from the LiDAR 5, which is mounted on the subject vehicle 101.

The LiDAR 5 is not capable of detecting the speed in a direction perpendicular to a light irradiation angle. Therefore, when the moving objects MO1 and MO2 move on the broken line CL1 as illustrated in FIG. 2, their moving directions are perpendicular to the light irradiation angle of the LiDAR 5, so the relative moving speeds of the moving objects MO1 and MO2 to be measured by the LiDAR 5 remain zero, and do not change. As a result, the moving objects MO1 and MO2 are each detected as a stationary object, instead of a moving object, and the measurement points respectively corresponding to the moving objects MO1 and MO2 are classified into the stationary point cloud data. Therefore, in the method for performing the clustering processing only on the moving point cloud data, the moving objects MO1 and MO2, which move in a direction perpendicular to the light irradiation angle of the LiDAR 5, may be excluded from the target of the clustering processing. In this case, the moving objects MO1 and MO2 will be lost from view, and the moving objects MO1 and MO2 cannot be accurately tracked. Hence, in the present embodiment, the clustering processing is performed on the point cloud data as follows, so that it becomes possible to accurately detect a moving object, while reducing a calculation load.

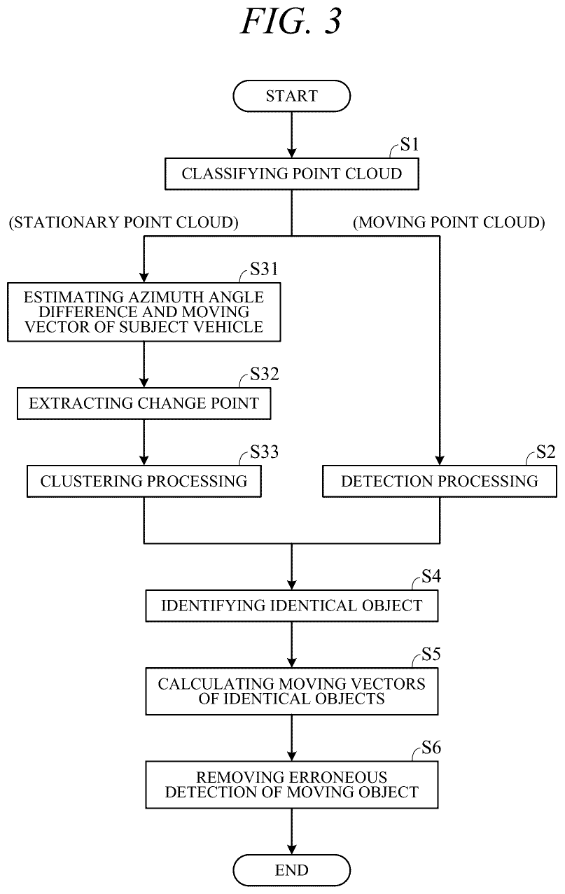

FIG. 3 is a flowchart illustrating an example of processing to be performed by the CPU of the controller 10 in FIG. 1, in accordance with a predetermined program. The processing illustrated in this flowchart is repeated at a predetermined cycle, while the object detection apparatus 50 is running. More specifically, the processing is repeated whenever the detection data of the LiDAR 5 is acquired by the data acquisition unit 111, that is, in every predetermined period of time.

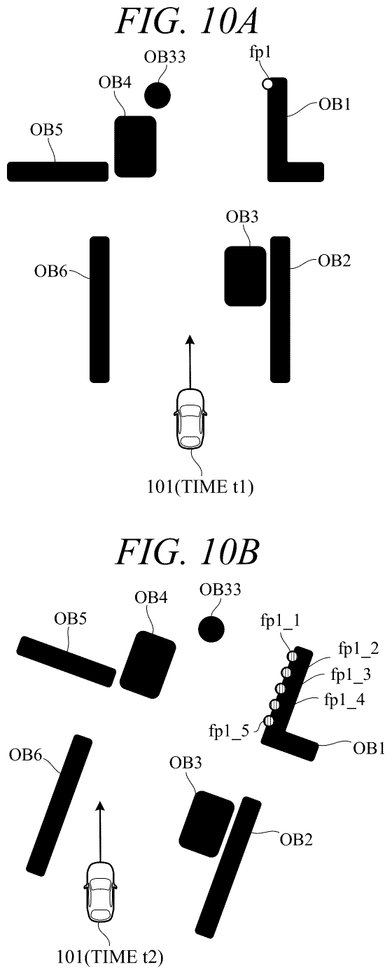

When the detection data (point cloud data) of the LiDAR 5 is acquired, first, processing (step S1) of classifying the point cloud data into the moving point cloud data and the stationary point cloud data is performed. Next, detection processing (step S2) of the moving object with respect to moving point cloud data and detection processing (steps S31 to S33) of the moving object with respect to stationary point cloud data are performed in parallel. Note that the detection processing (step S2) and the detection processing (steps S31 to S33) may not be necessarily performed in parallel. After either one of them may be performed, the other one may be performed. Next, on the moving object that has been detected, processing of identifying identical objects between frames (between a current frame and a previous frame) (step S4) is performed, and then processing of calculating moving vectors of the moving objects that have been identified as the identical objects (step S5) is performed. Note that in the detection processing of the moving object with regard to the stationary point cloud data (steps S31 to S33), erroneous detection of the moving object to be described later with reference to FIGS. 10A and 10B may occur. Therefore, in order to further improve the detection accuracy of the moving object, processing of removing the above-described erroneous detection (S6) is finally performed. In the detection processing of the moving object with respect to the moving point cloud data (step S2), clustering processing is performed on the moving point cloud data. In the detection processing of the moving object with respect to the stationary point cloud data (steps S31 to S33), first, in step S31, predetermined scan matching processing is performed to superimpose the stationary point cloud data of the previous frame on the stationary point cloud data of the current frame, and an azimuth angle difference and a moving vector of the subject vehicle 101 are estimated. The moving vector represents a moving direction of a representative point (such as a center of gravity) of the subject vehicle 101 between the frames and a moving speed in such a moving direction. The azimuth angle difference is an angle difference in azimuth (advancing direction) between the current frame and the previous frame of the subject vehicle 101. Hereinafter, an X axis is defined as an axis along an advancing direction of the subject vehicle 101, and a Y axis and Z axis are respectively defined as a lateral direction and a height direction with respect to the advancing direction. Note that the moving vector may be in two dimensions (X, Y) or three dimensions (X, Y, Z). In addition, the azimuth angle difference may be a one-axis angle (Z-axis rotation angle), a two-axis angle (X-axis rotation angle and Z-axis rotation angle), or a three-axis angle (X-axis rotation angle, Y-axis rotation angle, and Z-axis rotation angle). For the scan matching processing, iterative closest point (ICP) or normal distributions transform (NDT) may be used, or any other method may be used. Next, in step S32, a distance differential value between each measurement point of the previous frame and each measurement point of the current frame that correspond to each other and that have been detected by superimposition (superimposition of the stationary point cloud data of the previous frame and the stationary point cloud data of the current frame) in the scan matching processing of step S31 is calculated. Then, a measurement point, the distance differential value of which is equal to or larger than a predetermined threshold, is extracted as a change point. Finally, in step S33, the clustering processing is performed on the measurement point cloud that has been extracted (change point cloud). Note that the azimuth angle difference and the moving vector of the subject vehicle 101 estimated in step S31 are accumulated, and self-position estimation processing (not illustrated) for estimating the self-position (the traveling position of the subject vehicle 101) is performed, based on the azimuth angle difference and the moving vector that have been accumulated.

The processing in each step of FIG. 3 will be described in detail.

### <Classification of Point Cloud (S1)>

The estimation unit 112 estimates the absolute moving speed of the subject vehicle 101, based on the point cloud data that has been acquired by the data acquisition unit 111. Here, the estimation of the absolute moving speed of the subject vehicle 101 by the estimation unit 112 will be described.

First, the estimation unit 112 extracts point cloud data obtained by removing information of measurement points corresponding to a three-dimensional object from the point cloud data that has been acquired by the data acquisition unit 111, that is, point cloud data corresponding to a road surface (hereinafter, referred to as road surface point cloud data) in the surroundings of the subject vehicle 101. Note that the road surface point cloud data may be extracted in a plane approximation method, or may be extracted in any other method. The estimation unit 112 calculates a unit vector ei indicating the direction of a relative moving speed vi, based on the road surface point cloud data, that is, position coordinates (xi, yi, zi) included in four-dimensional data (xi, yi, zi, vi) of the measurement points Pi (i=1, 2, . . . , n) corresponding to the road surface. Specifically, the estimation unit 112 calculates the unit vector ei in the following formula (i).

$${e}_{i} = \frac{( {x}_{i} , {y}_{i} , {z}_{i} )}{‖ {x}_{i} , {y}_{i} , {z}_{i} ‖} = ( {x}_{ei} , {y}_{ei} , {z}_{ei} ) \qquad Formula ( i )$$

Next, the estimation unit 112 estimates a moving speed (absolute moving speed) Vself of the subject vehicle 101. Specifically, the estimation unit 112 sets a conversion formula for converting the relative moving speed vi of a measurement point Pi corresponding to the road surface into the absolute moving speed, as an objective function L, and solves an optimization problem for optimizing the objective function L to be closer to zero. The measurement point Pi is a measurement point on the road surface, and thus the absolute speed of each measurement point must be zero. Therefore, by optimizing the objective function L to be closer to zero, it becomes possible to estimate Vself that is correct. Vself is represented by speed components in XYZ-axis directions as indicated in the following formula (ii). The objective function L is expressed by the following formula (iii).

By solving the above optimization problem, Vself that makes the right side of formula (iii) zero is searched for. Note that zero may be set to Vself as an initial value, or Vself that has been estimated in a previous frame may be set.

$${V}_{self} = ( {v}_{x} , {v}_{y} , {v}_{z} ) \qquad Formula ( ii )$$

$$L ( V , f ( A , {V}_{self} ) ) = V + A \cdot {{V}_{self}}^{T} \qquad Formula ( iii )$$

In the formula (iii), A denotes a matrix of unit vectors ei of n measurement points corresponding to the road surface, and is expressed by a formula (iv). In addition, in the formula (iii), V denotes a matrix of 1×n representing speed components (the relative moving speeds) of n measurement points Pi corresponding to the road surface, and is expressed by a formula (v). The estimation unit 112 acquires Vself, which is obtained by solving the above optimization problem, as an estimated value of the absolute moving speed of the subject vehicle 101 in the current frame.

$$A = {[ {e}_{1} , {e}_{2} , ⋯ , {e}_{n} ]}^{T} = [ \begin{matrix}{x}_{e 1} & {y}_{e 1} & {z}_{e 1} \\ {x}_{e 2} & {y}_{e 2} & {z}_{e 2} \\ ⋮ & ⋮ & ⋮ \\ {x}_{en} & {y}_{en} & {z}_{en}\end{matrix} ] \qquad Formula ( iv )$$

$$V = {[ {v}_{1} , {v}_{2} , ⋯ , {v}_{n} ]}^{T} \qquad Formula ( v )$$

The speed calculation unit 113 calculates the absolute moving speeds of all measurement points, more specifically, all measurement points including the measurement points corresponding to the three-dimensional object, based on the absolute moving speed Vself of the subject vehicle 101 that has been estimated by the estimation unit 112. Here, the absolute moving speed that has been calculated has a negative value when approaching the subject vehicle, and has a positive value when leaving the subject vehicle.

The classification unit 114 classifies the point cloud data that has been acquired by the data acquisition unit 111 into moving point cloud data corresponding to the measurement point at which the absolute value of the absolute moving speed that has been calculated by the speed calculation unit 113 is equal to or higher than a predetermined speed Th_V and stationary point cloud data corresponding to the measurement point at which the absolute value is lower than the predetermined speed Th_V.

### <Estimation of Moving Vector (S31)>

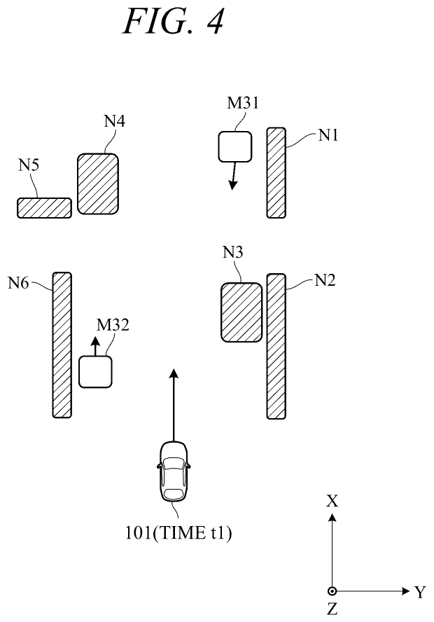

FIGS. 4, 5A, 5B, 6A, and 6B are each a diagram for describing processing of estimating, by the estimation unit 112, a moving vector and an azimuth angle of the subject vehicle 101 between frames (step S31). In FIG. 4, an arrow applied to the subject vehicle 101 indicates a moving direction (an advancing direction) of the subject vehicle 101, that is, the X-axis direction. In addition, a lateral direction (a left-right direction in FIG. 4) and a height direction (a direction from the depth side to the near side in FIG. 4) with respect to the X-axis direction respectively represent the Y-axis direction and the Z-axis direction. Note that because the definitions of the X-axis direction, the Y-axis direction, and the Z-axis direction are also similar in the other drawings, indications of X-axis, Y-axis, and Z-axis are omitted in such drawings. FIG. 4 illustrates an example of a schematic diagram when the point cloud data that has been acquired by the LiDAR 5 at a past time (time t1) is viewed from a top surface (Z-axis direction). Regions N1 to N6 each schematically represent the measurement point cloud corresponding to the stationary object, more specifically, the position and the size of the measurement point cloud. The stationary object includes a road surface of a road on which the subject vehicle 101 is traveling, a structure such as a wall or a separation zone installed on a lateral side of the road, other vehicles parked on a road shoulder, and the like. Regions M31 and M32 each schematically represent the measurement point cloud corresponding to a moving object, more specifically, the position and the size of the measurement point cloud. Note that hereinafter, a target object to be detected by the LiDAR 5 will be referred to as an object including a person. Therefore, a moving object includes a moving person (a pedestrian or the like), in addition to a moving vehicle such as an automobile or a bicycle. Arrows applied to the regions M31 and M32 respectively indicate the moving directions of the moving objects.

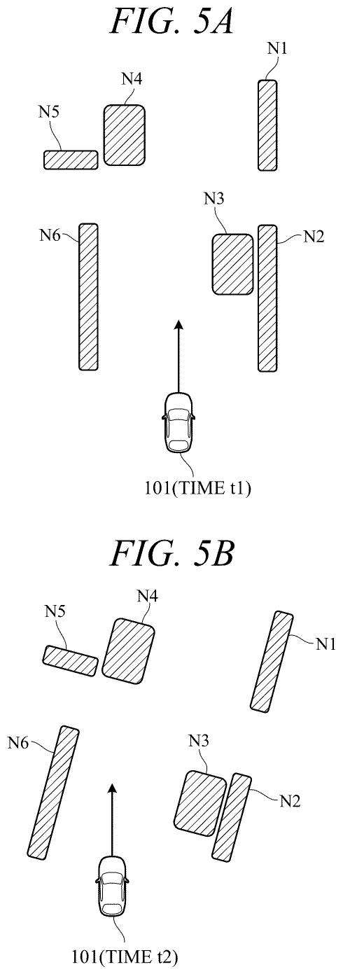

FIG. 5A schematically illustrates the point cloud data of FIG. 4, that is, the stationary point cloud data that has been classified from the point cloud data acquired by the LiDAR 5 at the past time (time t1). FIG. 5B schematically illustrates the stationary point cloud data that has been classified from the point cloud data acquired by the LiDAR 5 at a current time (time t2), when a predetermined period of time has elapsed from the predetermined past time (time t1).

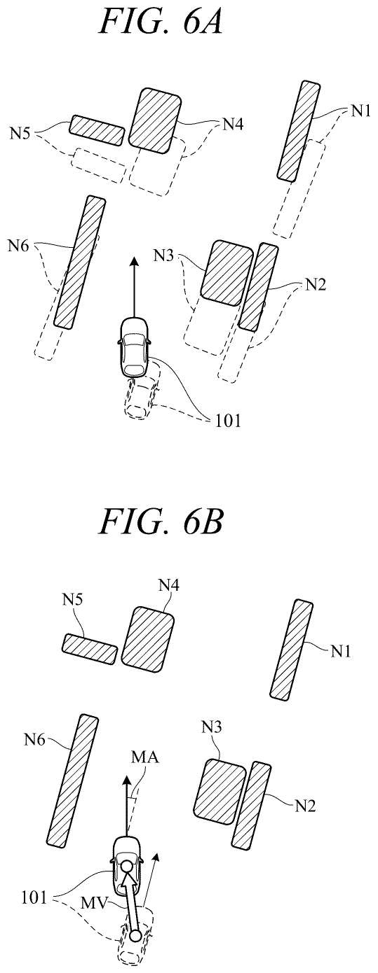

The estimation unit 112 first aligns the positions of the stationary point cloud data of the previous frame (FIG. 5A) with the stationary point cloud data of the current frame (FIG. 5B), and estimates an azimuth angle difference and a moving vector of the subject vehicle 101 in a predetermined period of time (between the frames). FIGS. 6A and 6B schematically illustrate a situation in which the positions of the stationary point cloud data of the previous frame (FIG. 5A) and the stationary point cloud data of the current frame (FIG. 5B) are aligned with each other. In FIG. 6A, the stationary point cloud data of the previous frame is indicated by broken lines, and the stationary point cloud data of the current frame is indicated by solid lines. The estimation unit 112 searches for (estimates) the azimuth angle difference and the moving vector of the subject vehicle 101 so that the measurement point clouds N1 to N6 of the previous frame indicated by the broken lines respectively superimpose (match) the measurement point clouds N1 to N6 of the current frame indicated by the solid lines. FIG. 6B illustrates the stationary point cloud data of the previous frame and the stationary point cloud data of the current frame after the position alignment. In FIG. 6B, an angle MA represents the azimuth angle difference of the subject vehicle 101 between the frames. A white arrow MV represents the moving vector of the subject vehicle 101 between the frames. A white circle in the drawing schematically represents the center of gravity of the subject vehicle 101. The estimation unit 112 solves an optimization problem that minimizes a deviation (error) between the positions of the measurement point clouds N1 to N6 in the previous frame and the positions of the measurement point clouds N1 to N6 in the current frame after the position alignment, and outputs a final search result (an estimation result) of the azimuth angle difference and the moving vector of the subject vehicle 101. Note that in order to reduce the calculation load, after the three-dimensional point cloud data is converted into two-dimensional point cloud data represented in an XY coordinate system, the above position alignment may be performed.

### <Extraction of Change Point (S32)>

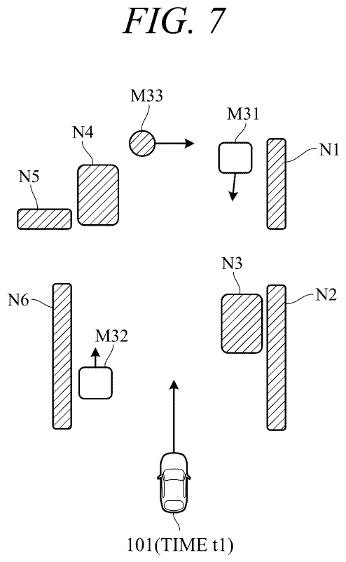

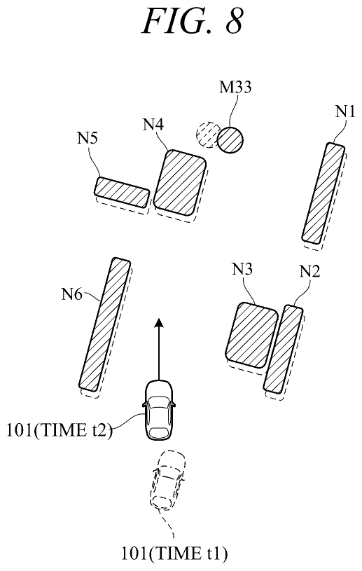

FIGS. 7 and 8 are diagrams for describing extraction processing of a change point (step S32). FIG. 7 illustrates another example of the schematic diagram when the point cloud data acquired by the LiDAR 5 at the past time (time t1) is viewed from the top surface (Z-axis direction). The point cloud data illustrated in FIG. 7 is similar to the point cloud data illustrated in FIG. 4, but the point cloud data illustrated in FIG. 7 includes a measurement point cloud (a region M33) corresponding to a moving object that moves in the direction perpendicular to the light irradiation angle of the LiDAR 5. In FIG. 7, shaded regions respectively represent the measurement point clouds that have been classified as the stationary point cloud data. As described above, the LiDAR 5 is not capable of detecting the speed in a direction perpendicular to the light irradiation angle. Thus, as illustrated in FIG. 7, an object corresponding to the region M33 is erroneously detected as a stationary object, instead of a moving object. Hence, the extraction unit 115 calculates a change amount (a moved amount) of the position between the frames (a predetermined period of time) of each measurement point of the stationary point cloud data, and also extracts, as a change point, a measurement point, the change amount of which is equal to or larger than a predetermined threshold, so that the object corresponding to the region M33 is detected as the moving object. FIG. 8 illustrates a situation in which the change point is extracted from the stationary point cloud data. In FIG. 8, the stationary point cloud data (FIG. 7) of the previous frame is indicated by broken lines, and the stationary point cloud data of the current frame is indicated by solid lines. In addition, FIG. 8 illustrates a situation in which the point cloud data of the previous frame is aligned in position with the point cloud data of the current frame with use of the moving vector and the azimuth angle difference of the subject vehicle that have been estimated by the estimation unit 112. As illustrated in FIG. 8, the position of the measurement point cloud M33, which corresponds to the moving object, but erroneously detected as the stationary object, largely changes between the frames, as compared with the other measurement point clouds N1 to N6. Therefore, each measurement point of the measurement point cloud M33 is extracted as a change point by the extraction unit 115. Hereinafter, the point cloud data corresponding to the change point (change point cloud) that has been extracted by the extraction unit 115 will be referred to as change point cloud data.

### <Clustering Processing (S2, S33)>

In step S2, the detection unit 116 performs the clustering processing on the moving point cloud data (the moving point cloud data classified from the point cloud data of the current frame in step S1). In addition, in step S33, the detection unit 116 performs the clustering processing on the change point cloud data extracted from the stationary point cloud data (the stationary point cloud data classified from the point cloud data of the current frame in step S1). Accordingly, a bounding box (a circumscribed region) corresponding to each of the measurement point clouds M31 and M32 is detected from the moving point cloud data, and a bounding box corresponding to the measurement point cloud M33 is detected from the change point cloud data. The detection unit 116 detects the position and the size of the bounding box that has been detected, as the position and the size of the moving object. In this manner, a moving object included in a three-dimensional space in the surroundings of the subject vehicle 101 is detected. The detection unit 116 outputs information (image information or the like) indicating a detection result of the moving object on a display device, not illustrated, or the like. Note that any method such as density-based spatial clustering of applications with noise (DBSCAN) or K-means clustering may be used for the clustering processing by the detection unit 116.

### <Identification of Identical Object (S4)>

The determination unit 117 determines whether the moving object that has been detected from the previous frame and the moving object that has been detected from the current frame are identical objects.

Specifically, first, the determination unit 117 performs offset rotation processing of offsetting (a parallel movement) and rotating each bounding box that has been detected in the clustering processing by the detection unit 116 in the previous frame, based on the moving vector and the azimuth angle difference of the subject vehicle 101 between the frames estimated in step S31. In the offset rotation processing, the determination unit 117 first offsets each bounding box that has been detected in the previous frame in accordance with the above moving vector, and rotates each bounding box by the above azimuth angle difference. Next, the determination unit 117 further offsets each bounding box that has been offset and rotated, based on the moving vector of the corresponding moving object. Specifically, the bounding boxes of the measurement point clouds M31, M32, and M33 are further offset by the moved amount obtained by multiplying the vector amount of the moving vector of the moving object corresponding to the measurement point clouds M31, M32, and M33 by a frame time (a predetermined period of time). The moving vector of the moving object will be described later.

As described above, the determination unit 117 superimposes, on the current frame, each of the bounding boxes of the previous frame that having been obtained by the offset rotation processing based on the moving vector and the azimuth angle difference of the subject vehicle 101 and the offset processing based on the moving vector of the moving object. As a result of the superimposition, in a case where a bounding box is present in the current frame to be overlapped on the bounding box of the previous frame that has been obtained by the offset rotation processing and the offset processing, the determination unit 117 determines that the moving objects respectively corresponding to the overlapped bounding boxes are the identical objects. Note that the determination as to whether the bounding boxes are overlapped on each other may be made, based on whether their overlap ratio is equal to or larger than a predetermined threshold, or may be made, based on whether the distance between the centers of gravity of the bounding boxes is shorter than a predetermined length.

### <Calculation of Moving Vector (S5)>

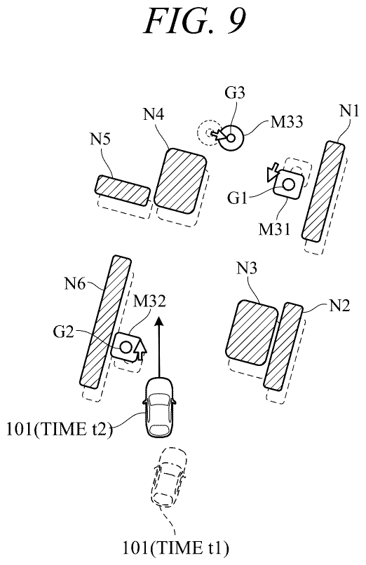

The vector calculation unit 118 calculates a moving vector of the moving object, based on a determination result of the determination unit 117. The calculation of the moving vector of the moving object will be described with reference to FIG. 9. FIG. 9 is a diagram for describing the moving vector of the moving object. In FIG. 9, the point cloud data of the previous frame is indicated by broken lines, and the point cloud data of the current frame is indicated by solid lines. FIG. 9 illustrates a situation in which the point cloud data of the previous frame that has been obtained by the offset rotation processing based on the moving vector and the azimuth angle difference of the subject vehicle 101 is superimposed on the point cloud data of the current frame. White circles G1, G2, and G3 respectively represent the centers of gravity of the measurement point clouds M31, M32, and M33, more specifically, the centers of gravity of the bounding boxes of the measurement point clouds M31, M32, and M33 that have been detected in the clustering processing by the detection unit 116. The vector calculation unit 118 calculates the moving vectors of the moving objects respectively corresponding to the measurement point clouds M31, M32, and M33, based on a positional relationship among the centers of gravity G1, G2, and G3 (between the previous frame and the current frame). The vector calculation unit 118 stores the moving vector of the moving object that has been calculated, in the memory unit 12, together with information (an identifier) with which the moving object is identifiable. The moving vector of the moving object stored in the memory unit 12 is used in the offset processing based on the moving vector of the moving object next time, that is, the offset processing in step S4 to be performed on the next frame. This enables accurate identification of the identical objects in the next frame, and the position, the moving direction, and the moving speed of the moving object can be satisfactorily tracked.

### <Removal of Erroneously Detected Moving Object (S6)>

FIGS. 10A and 10B are diagrams for describing erroneous detection of a moving object in the detection processing of the moving object on the change point cloud data. FIG. 10A illustrates an example of a schematic diagram when a forward space of the subject vehicle 101 at the past time point (time t1) is viewed from the upper surface (Z-axis direction). Objects OB1 to OB6 in FIG. 10A schematically represent stationary objects respectively corresponding to the measurement point clouds N1 to N6 in FIG. 7. An object OB33 schematically represents a moving object corresponding to the measurement point cloud M33 in FIG. 7.

As illustrated in FIG. 10A, when the objects OB2 and OB3 are present between the object OB1 and the subject vehicle 101, the object OB1 is hidden behind the objects OB2 and OB3, and the electromagnetic wave that has been irradiated by the LiDAR 5 reaches only a partial region of the object OB1. In this case, as the measurement point cloud corresponding to the object OB1, a measurement point cloud corresponding to a part of the object OB1, specifically, a region on which the electromagnetic wave that has been irradiated by the LiDAR 5 reaches is actually acquired, instead of the measurement point cloud corresponding to the entirety of the object OB1 like the measurement point cloud N1 in FIG. 7. Note that in FIG. 10A, for simplification of the drawing, only a measurement point fp1 is indicated as an example, as the measurement point cloud corresponding to the object OB1 acquired at this time. In addition, in FIG. 10A, for simplification of the drawing, drawing of the measurement point cloud corresponding to any object other than the object OB1 is omitted.

FIG. 10B illustrates an example of a schematic diagram when the forward space of the subject vehicle 101 is viewed from the upper surface (Z-axis direction) at the current time (time t2) when a predetermined time has elapsed from the past predetermined time (time t1). As the subject vehicle 101 moves from time t1 to time t2, as illustrated in FIG. 10B, the electromagnetic wave that has been irradiated by the LiDAR 5 reaches the region that was hidden behind the objects OB2 and OB3 at time t1. As a result, as illustrated in FIG. 10B, at time t2, measurement points fp1_1 to fp1_5 are acquired as the measurement point cloud corresponding to the object OB1. Note that the measurement point fp1_1 in FIG. 10B corresponds to the measurement point fp1 in FIG. 10A.

In the scan matching processing performed in step S31, the measurement point fp1 in FIG. 10A has to be associated with the measurement point fp1_1 in FIG. 10B. However, as illustrated in FIG. 10B, when the measurement points fp1_2 to fp1_5 that were not acquired at time t1 are newly acquired because the subject vehicle 101 moved, there is a possibility that the measurement point fp1 is associated with any one of the measurement points fp1_2 to fp1_5, instead of the measurement point fp1_1. In this case, it is erroneously determined that the position of the measurement point fp1 has changed between the frames (in a predetermined period of time). In addition, in a case where such a change amount (moved amount) is equal to or larger than a predetermined threshold, any one of the measurement points fp1_2 to fp1_5 is erroneously detected as a change point in step S32. In this manner, when the measurement points (the measurement points fp1_2 to fp1_5 in the example of FIG. 10B) corresponding to the region newly included in the field of view (FOV) of the LiDAR 5 are erroneously extracted as the change point because the subject vehicle 101 moved, the object OB1, which is a stationary object, is erroneously detected as a moving object corresponding to the change point cloud in step S33.

Therefore, the removing unit 119 identifies the moving object that has been erroneously detected as described above from the moving objects (hereinafter, referred to as candidate moving objects) detected in step S33 as follows. Then, the removing unit 119 removes the moving object that has been erroneously detected. Specifically, the removing unit 119 deletes, from the memory unit 12, information of the moving object that has been erroneously detected (the identifier of the moving object and the moving vector stored in the memory unit 12 in step S5).

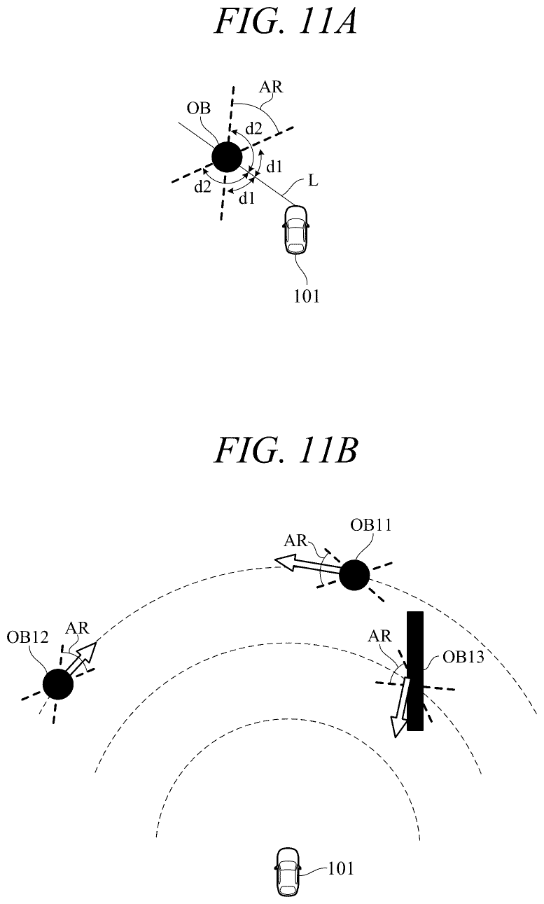

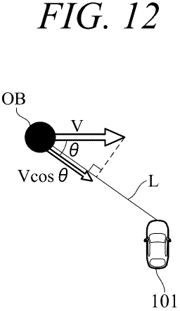

FIGS. 11A and 11B are diagrams for describing an example of a method for identifying the moving object that has been erroneously detected. The removing unit 119 determines whether an angle formed by the moving vector of the moving object corresponding to the change point cloud calculated in the calculation of the moving vector (S5) and a line segment that connects the LiDAR 5 with a representative point (for example, the center of gravity) of the moving object falls within an angle range AR. As illustrated in FIG. 11A, the angle range AR is a range between angles d1 and d2 with respect to a line segment L, which connects the LiDAR 5 with the representative point of the object OB to be a determination target. The angle d1 is, for example, 60 degrees, and the angle d2 is, for example, 120 degrees. Note that the angles d1 and d2 may be any other values. In a case where the angle formed by the moving vector of the object OB and the line segment L falls within the angle range AR, the removing unit 119 determines that the measurement point cloud corresponding to the object OB has been extracted as the change point cloud in step S32 because the object OB moved in the direction perpendicular to the light irradiation angle of the LiDAR 5. In this situation, the removing unit 119 determines that the object OB is a true moving object. On the other hand, in a case where the angle formed in such a manner is outside the angle range AR, it is determined that the measurement point cloud corresponding to the object OB is erroneously extracted as the change point cloud in step S32 because the subject vehicle 101 moved, and the object OB is determined to be a moving object that has been erroneously detected. More specifically, in the case where the above angle is outside the angle range AR, if the object is actually moving, the relative moving speed of the object is equal to or larger than the threshold in step S1, and the measurement point cloud corresponding to the object should be classified into the moving point cloud data. Thus, it is possible to determine an object that is determined as the stationary point cloud data in step S1 and that the above angle is outside the angle range AR, as the moving object that has been erroneously detected. In the example illustrated in FIG. 11B, the angle formed by the line segment that connects the subject vehicle 101 (LiDAR 5) with the object OB11 and the moving vector of the object OB11 falls within the angle range AR, and the angle formed by the line segment that connects the subject vehicle 101 (LiDAR 5) with the object OB12 and the moving vector of the object OB12 falls within the angle range AR. Therefore, both the objects OB11 and OB12 are determined to be true moving objects. On the other hand, as the angle formed by the line segment that connects the subject vehicle 101 (LiDAR 5) with the object OB13 and the moving vector of the object OB13 is outside the angle range AR, the object OB13 is determined to be the moving object that has been erroneously detected. In this manner, the moving object that has been erroneously detected is identified from among the candidate moving objects. Note that broken lines in the drawing are each an imaginary line that connects between points equal in distance from the LiDAR 5, which is mounted on the subject vehicle 101. In addition, white arrows in the drawing each schematically represent the moving vector of each object.

FIG. 12 is a diagram for describing another example of the method for identifying the moving object that has been erroneously detected. The removing unit 119 may determine whether the object OB is the moving object that has been erroneously detected, based on a component Vcos0 on the line segment L having a size (velocity) V of the moving vector of the object OB, which is a determination target. The angle θ denotes an angle formed by the line segment L and the moving vector. In a case where the absolute value of Vcose is equal to or larger than the predetermined speed Th_V, the removing unit 119 determines that the object OB is the moving object that has been erroneously detected, because the measurement point cloud corresponding to the object OB must have already been classified as the moving point cloud data in step S1.

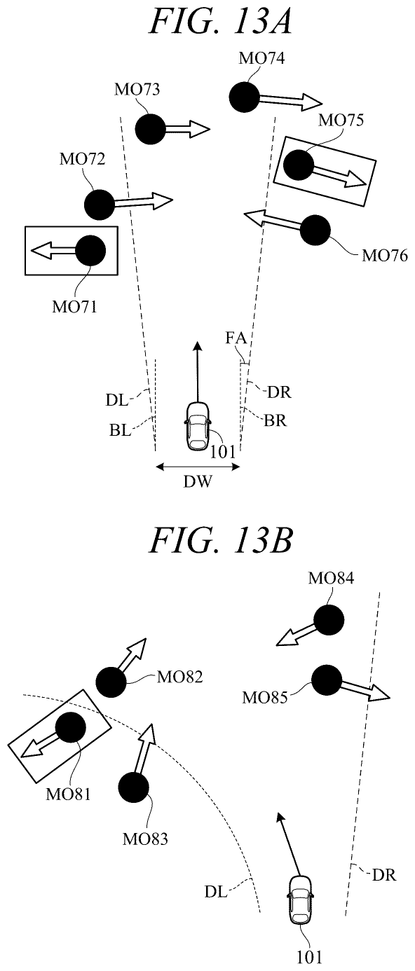

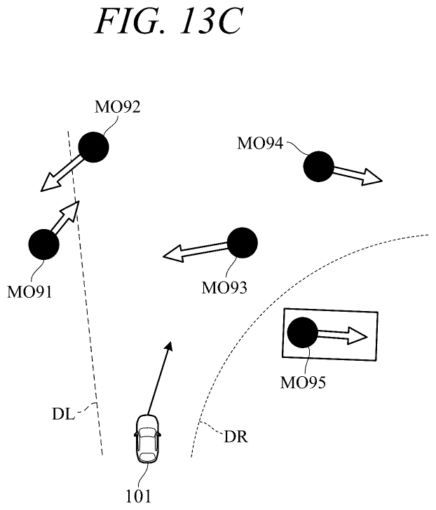

Note that in step S6, the removing unit 119 may remove not only the moving object that has been erroneously detected but also a moving object having a low possibility of approaching or colliding with the subject vehicle 101. Specifically, the removing unit 119 determines the possibility of the moving object and the subject vehicle 101 approaching or colliding with each other, based on the moving direction and the position of the moving object (candidate moving object) detected in step S33. In a case where the possibility of approaching or colliding is smaller than a predetermined degree, the removing unit 119 may remove the moving object from the candidate moving objects. Specifically, the information of the moving object (the identifier of the moving object and the motion vector stored in the memory unit 12 in step S5) may be deleted from the memory unit 12. FIGS. 13A, 13B, and 13C are diagrams for describing a degree of the possibility that the subject vehicle 101 approaches or collides with a moving object.

Broken lines BL and BR illustrated in FIG. 13A are straight lines along the vehicle length direction of the subject vehicle 101, and are a pair of left and right straight lines having the same width as the road width (lane width) or a preset width. Dashed lines DL and DR are boundary lines for determining whether the moving object is to be a removal target. The removing unit 119 determines whether the degree of the possibility of approaching or colliding with the subject vehicle 101 is equal to or larger than a predetermined degree, based on the boundary lines DL and DR, and selects a moving object having the degree of the possibility smaller than the predetermined degree, as the removal target. Specifically, the removing unit 119 determines that a moving object which is present outside the boundary lines DL and DR and the moving vector of which is not directed to the inside of the boundary lines DL and DR, that is, a moving object that does not enter a region defined by the boundary lines DL and DR when moving in the direction of the moving vector, as the moving object having the degree of the possibility of approaching or colliding with the subject vehicle 101 smaller than the predetermined degree, and selects the moving object as the removal target. White arrows in the drawing each schematically represent a moving vector of each object. While the subject vehicle 101 is moving straight ahead, the boundary lines DL and DR are each set to have a margin of a predetermined angle FA from the broken lines BL and BR relative to the advancing direction of the subject vehicle 101, as illustrated in FIG. 13A. In the example illustrated in FIG. 13A, from among moving objects MO71 to MO76 which are candidate moving objects, the moving objects MO71 and MO75 are selected as the removal targets, and are removed from the candidate moving objects. Square frames in the drawing schematically represent states in which the moving objects MO71 and MO75 are selected as the removal targets.

FIG. 13B illustrates a situation in which the subject vehicle 101 travels while turning to the left. As illustrated in FIG. 13B, when the subject vehicle 101 turns to the left, the removing unit 119 changes the boundary line DL on the left side. Specifically, the removing unit 119 sets the boundary line DL as illustrated in FIG. 13B in accordance with a curve curvature of the subject vehicle 101. The curve curvature may be calculated, based on a target path of the subject vehicle 101, or may be calculated, based on sensor values of the internal sensor group 3 (the yaw rate sensor, the vehicle speed sensor, and the steering angle sensor). The removing unit 119 selects, as the removal target, a moving object which is present outside the boundary lines DL and the moving vector of which is not directed to the inside of the boundary lines DL and DR. In the example illustrated in FIG. 13B, from among moving objects MO81 to MO85 which are the candidate moving objects, it is determined that the degree of the possibility that the moving object MO81 approaches or collides with the subject vehicle 101 is smaller than the predetermined degree, and the moving object MO81 is selected as the removal target.

FIG. 13C illustrates a situation in which the subject vehicle 101 travels while turning to the right. When the subject vehicle 101 turns to the right, the removing unit 119 changes the boundary line DR on the right side, as illustrated in FIG. 13C. Similarly to the left boundary line DL, the removing unit 119 sets the boundary line DR on the right side in accordance with a curve curvature of the subject vehicle 101. In the example illustrated in FIG. 13C, from among moving objects MO91 to MO95 which are the candidate moving objects, it is determined that the degree of the possibility that the moving object MO95 approaches or collides with the subject vehicle 101 is smaller than the predetermined degree, and the moving object MO95 is selected as the removal target. According to the embodiments that have been described heretofore, the following effects are obtained.

(1) The object detection apparatus 50 includes: the LiDAR 5, which is mounted on the subject vehicle 101 as a moving body, and which serves as a detection unit that irradiates surroundings of the subject vehicle 101 with an electromagnetic wave and that detects an exterior environment situation in the surroundings of the subject vehicle 101, based on a reflected wave; the data acquisition unit 111, which acquires point cloud data that has been detected by the LiDAR 5 in every predetermined period of time, the point cloud data including position information of a measurement point on a surface of the object from which the reflected wave is obtained and first speed information indicating a relative moving speed of the measurement point; the estimation unit 112, which serves as a speed acquisition unit that acquires second speed information indicating an absolute moving speed of the subject vehicle 101; the speed calculation unit 113, which calculates an absolute moving speed of each of a plurality of measurement points corresponding to the point cloud data, based on the first speed information and the second speed information; the classification unit 114, which classifies the point cloud data that has been acquired by the data acquisition unit 111 into moving point cloud data as first point cloud data and stationary point cloud data as second point cloud data other than the first point cloud data, the first point cloud data corresponding to the measurement point on the surface of the object having an absolute value of the absolute moving speed that has been calculated by the speed calculation unit 113, the absolute value being equal to or larger than a predetermined speed; the extraction unit 115, which calculates a moved amount of a measurement point corresponding to the stationary point cloud data for a predetermined period of time, and which also extracts, from the stationary point cloud data, change point cloud data as predetermined point cloud data corresponding to the measurement point having the moved amount equal to or larger than a predetermined value; and the detection unit 116, which identifies the moving object from among objects that have been detected by the LiDAR 5, based on the moving point cloud data and the change point cloud data. The moving object includes: a first moving object (for example, the moving objects respectively corresponding to the measurement point clouds M31 and M32 in FIG. 7) that has been identified, based on the moving point cloud data; and a second moving object (for example, the moving object corresponding to the measurement point cloud M33 in FIG. 7) that has been identified, based on the change point cloud data. The detection unit 116 extracts a candidate moving object to become a candidate of the second moving object from the objects that have been detected by the LiDAR 5, based on the change point cloud data, and determines whether the candidate moving object is the second moving object, based on at least one of the moving speed and the moving direction of the measurement point corresponding to the candidate moving object. This enables suppression of erroneous detection of the stationary object as the moving object due to a change in the FOV of the LiDAR 5. This also enables suppression of erroneous detection of a moving object that moves in a direction perpendicular to the light irradiation angle of the LiDAR 5, as the stationary object. As a result, it becomes possible to accurately detect the moving object.

(2) In a case where an angle formed by a moving direction of a candidate moving object that has been extracted from the change point cloud data and a line segment that connects the candidate moving object with the LiDAR 5 is included in the predetermined angle range AR, the detection unit 116 determines that the candidate moving object is the second moving object. Accordingly, also when the FOV of the LiDAR 5 changes, it becomes possible to accurately identify the moving object.

(3) The detection unit 116 determines a possibility that an object and the subject vehicle 101 approach or collide with each other, based on the moving direction and the position of the object that has been detected as the candidate moving object based on predetermined point cloud data, and removes the object having the possibility smaller than a predetermined degree from the candidate moving object. This enables a reduction in number of the candidate moving objects, so that the processing load in the erroneous detection determination of the moving object can be reduced.

(4) The estimation unit 112 estimates the absolute moving speed of the subject vehicle 101, based on the position information and the speed information of a representative measurement point (road surface point cloud data) that has been extracted from the point cloud data acquired by the data acquisition unit 111, and also acquires an estimation result as the speed information. The representative measurement point is selected from remaining measurement points in which the measurement point corresponding to a three-dimensional object is excluded from the plurality of measurement points. Accordingly, the absolute moving speed of the subject vehicle 101 is estimated with reference to the measurement point corresponding to the road surface. As a result, it becomes possible to accurately estimate the absolute moving speed of the subject vehicle 101. In addition, the absolute moving speed of the subject vehicle (the moving body) 101 is estimated and acquired, regardless of a sensor value of a vehicle speed sensor or the like. Therefore, the present invention is applicable to a self-propelled robot or the like that does not include the vehicle speed sensor or the like.

The above embodiments can be modified in various manners. Hereinafter, modifications will be described. In the above embodiment, the LiDAR 5 as the detection unit is mounted on the vehicle, irradiates the three-dimensional space in the surroundings of the vehicle with the electromagnetic wave, and detects the exterior environment situation in the surroundings of the vehicle, based on the reflected wave. However, the detection unit may be a radar or the like, instead of the LiDAR. In addition, the moving body on which the detection unit is mounted may be a self-propelled robot or the like, instead of the vehicle.

In addition, in the above embodiment, the estimation unit 112, which serves as the speed acquisition unit, selects the measurement point Pi as the representative measurement point from among the remaining measurement points in which the measurement point corresponding to the three-dimensional object is excluded from the plurality of measurement points, estimates the absolute moving speed of the subject vehicle 101, based on the position information and the speed information of the representative measurement point that has been extracted from the point cloud data acquired by the data acquisition unit 111, and acquires an estimation result as the second speed information. However, the speed acquisition unit may acquire, as the second speed information, the measurement result of the absolute moving speed of the subject vehicle 101 that has been acquired by a measuring instrument included in the internal sensor group 3. In this case, the object detection apparatus 50 includes at least the vehicle speed sensor of the internal sensor group 3, as the measuring instrument. In addition, the speed acquisition unit may calculate and acquire the absolute moving speed of the subject vehicle 101, based on the current position of the subject vehicle 101 that has been measured by the position measurement unit 2. In this case, the object detection apparatus 50 includes the position measurement unit 2.

In addition, in the above embodiment, the detection unit 116 performs the predetermined clustering processing on the three-dimensional point cloud data (the moving point cloud data and the change point cloud data), and detects the moving object from the three-dimensional point cloud data. However, the detection unit may generate speed added data (XYV data) obtained by adding the absolute moving speed of each measurement point that has been calculated by the speed calculation unit 113 to two-dimensional point cloud data obtained by projecting each measurement point corresponding to the three-dimensional point cloud data on the XY plane, and may perform the predetermined clustering processing on the speed added data. Accordingly, the clustering processing in consideration of the position and the moving speed of the moving object is performed. As a result, it becomes possible to suppress the detection of a plurality of moving objects in close proximity to each other, such as two moving objects that pass each other, as an integrated object (as one moving object), so that the detection accuracy of the moving object can be further improved. Note that in a case where the accuracy of the cluster size in the three-dimensional space (XYZ space) is demanded, the detection unit may generate speed added data (XYZV data) obtained by adding the absolute moving speed of each measurement point that has been calculated by the speed calculation unit 113 to the three-dimensional point cloud data, and may perform the predetermined clustering processing on the speed added data.

In the above embodiment, from among the objects that have been detected as the candidate moving objects, based on the predetermined point cloud data, the detection unit 116, which serves as a moving object identifying unit, removes an object having a possibility of approaching or colliding with the subject vehicle 101 smaller than a predetermined degree from the candidate moving objects. However, from among the objects that have been detected as the candidate moving objects, based on the predetermined point cloud data, the moving object identifying unit may remove, from the candidate moving objects, an object having a lateral width and a height that do not satisfy predetermined references. In a case where the lateral width of the object is smaller than a first reference value and the height is equal to or larger than a second reference value, the moving object identifying unit determines that the lateral width and the height of the object do not satisfy the predetermined references. The first reference value and the second reference value are set beforehand so that a moving object that cannot be actually present on the road or near the road is removed from the candidate moving objects. The first reference value is, for example, 1.5 meters, and the second reference value is, for example, 2.5 meters. Note that the first reference value and the second reference value are not limited to them. This enables a further reduction in number of the candidate moving objects, so that the processing load in the erroneous detection determination of the moving object can be reduced.

In addition, in the above embodiment, the estimation unit 112 aligns the positions of the stationary point cloud data (FIG. 5A) of the previous frame with the stationary point cloud data (FIG. 5B) of the current frame, and estimates the azimuth angle difference and the moving vector of the subject vehicle 101 in a predetermined period of time (between the frames). However, the estimation unit converts the three-dimensional stationary point cloud data into two-dimensional stationary point cloud data represented in an XY coordinate system, and then may align the positions as described above. Further, the estimation unit may align the positions as described above by using not only the stationary point cloud data of the past time (time t1) but also the stationary point cloud data of a plurality of past times, that is, by using not only the stationary point cloud data of the previous frame but also the stationary point cloud data of the plurality of past frames. In this manner, by using the stationary point cloud data of the plurality of past frames, it becomes possible to align the positions of the data as described above satisfactorily even when the stationary object on a forward side of the subject vehicle 101 is temporarily shielded by another vehicle or the like, so that the robustness can be improved.

Further, in the above embodiment, the driving control unit 120 conducts the travel control of the subject vehicle 101 to avoid collision or contact with the object that has been detected by the detection unit 116. However, the driving control unit 120, which serves as a notification unit, may predict a possibility of collision or contact with the moving object, based on the size, the position, and the moving speed of the moving object that has been detected by the detection unit 116. Then, in a case where the possibility of collision or contact with the moving object is equal to or higher than a predetermined degree, an occupant of the subject vehicle 101 may be notified of information (video information or audio information) for calling for attention about collision or contact with the moving object that has been detected by the detection unit 116 via a display or a speaker, not illustrated, included in the vehicle control device 100.

Furthermore, in the above embodiment, the object detection apparatus 50 is applied to a self-driving vehicle, but the object detection apparatus 50 is also applicable to any vehicle other than self-driving vehicle. For example, the object detection apparatus 50 is also applicable to a manual driving vehicle including advanced driver-assistance systems (ADAS).

The above embodiment can be combined as desired with one or more of the above modifications. The modifications can also be combined with one another.

According to the present invention, it becomes possible to accurately detect the moving object.

Above, while the present invention has been described with reference to the preferred embodiments thereof, it will be understood, by those skilled in the art, that various changes and modifications may be made thereto without departing from the scope of the appended claims.

What is claimed is:

1. An object detection apparatus comprising:
a detection unit configured to irradiate surroundings of a subject vehicle with an electromagnetic wave and detect an exterior environment situation around a moving body based on a reflected wave; and
a microprocessor, wherein
the microprocessor is configured to perform:
acquiring point cloud data detected by the detection unit in every predetermined period of time, the point cloud data including position information of a measurement point on a surface of an object from which the reflected wave is obtained and first speed information indicating a relative moving speed of the measurement point;
acquiring second speed information indicating absolute moving speed of the moving body;
calculating an absolute moving speed of each of a plurality of measurement points corresponding to the point cloud data, based on the first speed information and the second speed information;
classifying the point cloud data into first point cloud data and second point cloud data other than the first point cloud data, the first point cloud data corresponding to the measurement point on the surface of the object having an absolute value of the absolute moving speed, the absolute value being equal to or larger than a predetermined speed;
calculating a moved amount of the measurement point corresponding to the second point cloud data for the predetermined period of time;
extracting, from the second point cloud data, predetermined point cloud data corresponding to the measurement point having the moved amount equal to or larger than a predetermined value; and
identifying a moving object from among objects detected by the detection unit, based on the first point cloud data and the predetermined point cloud data, wherein
the moving body includes a first moving object identified based on the first point cloud data and a second moving object identified based on the second point cloud data, and
the microprocessor is configured to perform
the identifying including extracting a candidate moving object to become a candidate of the second moving object from the objects detected by the detection unit, based on the predetermined point cloud data, and determining whether the candidate moving object is the second moving object, based on at least one of a moving speed and a moving direction of the measurement point corresponding to the candidate moving object.

2. The object detection apparatus according to claim 1, wherein
the microprocessor is configured to perform the identifying including, in a case where an angle formed by a moving direction of the candidate moving object extracted from the predetermined point cloud data and a line segment connecting the candidate moving object with the detection unit is included in a predetermined angle range, determining that the candidate moving object is the second moving object.

3. The object detection apparatus according to claim 1, wherein
the microprocessor is configured to perform
the identifying including, in a case where an absolute value of a component on a line segment connecting the candidate moving object extracted from the predetermined point cloud data with the detection unit is equal to or larger than a predetermined speed, removing the moving object from the candidate moving objects, the component being a component of the moving speed of the candidate moving object.

4. The object detection apparatus according to claim 1, wherein
the microprocessor is configured to perform
the identifying including determining a possibility in which the object extracted as the candidate moving object based on the predetermined point cloud data and the moving object approach or collide with each other, based on a moving direction and a position of the object, and removing the object having the possibility smaller than a predetermined degree from the candidate moving object.

5. The object detection apparatus according to claim 1, wherein
the microprocessor is configured to perform
the identifying including removing an object having a lateral width and a height failing to satisfy a predetermined reference, from among the objects detected by the detection unit.

6. The object detection apparatus according to claim 1, wherein
the microprocessor is configured to perform
the acquiring of the second speed information including estimating the absolute moving speed of the moving object, based on the position information and the first speed information of a representative measurement point extracted from the point cloud data detected by the detection unit, and acquiring a result of the estimating as the second speed information, and
the representative measurement point is selected from remaining measurement points in which the measurement point corresponding to a three-dimensional object is excluded from the plurality of measurement points.

7. The object detection apparatus according to claim 1, wherein
the detection unit is LiDAR.
